(19) United States
(12) Patent Application Publication
(10) Pub. No.: US 2012/0012681 A1
(43) Pub. Date: Jan. 19, 2012

(54) FUEL INJECTOR HAVING BALANCED AND GUIDED PLUNGER

(75) Inventors: Lester L. PETERS, Columbus, IN (US); Vesa HOKKANEN, Columbus, IN (US); Corydon E. MORRIS, Columbus, IN (US); Marian TROCKI, Columbus, IN (US); Anthony A. SHAULL, Columbus, IN (US); Jeff HUANG, Columbus, IN (US)

(73) Assignee: CUMMINS INTELLECTUAL PROPERTIES, INC., Minneapolis, MN (US)

(21) Appl. No.: 13/184,147

(22) Filed: Jul. 15, 2011

Related U.S. Application Data
(60) Provisional application No. 61/364,520, filed on Jul. 15, 2010.

(51) Int. Cl. F02M 61/00

(52) U.S. Cl. 239/533.2

(57) ABSTRACT

A closed nozzle injector for injecting fuel at high pressure into the combustion chamber of an engine, is provided including a lower supply chamber positioned in the nozzle housing, an injector plunger including a lower guide sized to form a close sliding fit with a nozzle housing to guide the plunger during reciprocal movement, and a plurality of restriction orifices formed in the injector plunger and positioned about the injector plunger to restrict fuel flow from an upper supply chamber to the lower supply chamber. The lower guide is positioned axially between the lower supply chamber and the injection orifices.

### TECHNICAL FIELD

This invention relates to plungers for high pressure fuel injectors, and high pressure fuel injectors, for injecting fuel into an internal combustion engine.

### BACKGROUND

In most fuel supply systems applicable to internal combustion engines, fuel injectors are used to direct fuel pulses into the engine combustion chamber. A commonly used injector is a closed-nozzle injector which includes a nozzle assembly having a spring-biased nozzle valve element positioned adjacent the nozzle orifice for resisting blow back of exhaust gas into the pumping or metering chamber of the injector while allowing fuel to be injected into the cylinder. The nozzle valve element also functions to provide a deliberate, abrupt end to fuel injection thereby preventing a secondary injection which causes unburned hydrocarbons in the exhaust. The nozzle valve is positioned in a nozzle cavity and biased by a nozzle spring to block fuel flow through the nozzle orifices. In many fuel systems, when the pressure of the fuel within the nozzle cavity exceeds the biasing force of the nozzle spring, the nozzle valve element moves outwardly to allow fuel to pass through the nozzle orifices, thus marking the beginning of injection. In another type of system, such as disclosed in U.S. Pat. No. 5,676,114 to Tarr et al., the beginning of injection is controlled by a servo-controlled needle valve element. The assembly includes a control volume positioned adjacent an outer end of the needle valve element, a drain circuit for draining fuel from the control volume to a low pressure drain, and an injection control valve positioned along the drain circuit for controlling the flow of fuel through the drain circuit so as to cause the movement of the needle valve element between open and closed positions. Opening of the injection control valve causes a reduction in the fuel pressure in the control volume resulting in a pressure differential which forces the needle valve open, and closing of the injection control valve causes an increase in the control volume pressure and closing of the needle valve.

U.S. Pat. No. 6,499,467 issued to Morris et al. discloses a servo-controlled needle valve injector which also includes an inner restriction orifice to restrict the flow of fuel from a spring chamber to an inner control volume to create a desired force profile on the needle valve element. Likewise, FIG. 1 herein shows a similar servo-controlled injector including a plunger with an inner restriction orifice operating as explained in the '467 patent.

### SUMMARY

This disclosure provides a closed nozzle injector for injecting fuel at high pressure into the combustion chamber of an engine, comprising an injector body including an upper supply chamber and a nozzle housing, wherein the nozzle housing includes a lower supply chamber, a plunger seat, and injector orifices. An injector plunger is positioned in the nozzle housing for movement between a closed position in abutment against the plunger seat to block fuel flow through the injector orifices and an open position positioned a spaced distance from the plunger seat to permit fuel flow through the injector orifices. The injector plunger includes a lower guide sized to form a close sliding fit with the nozzle housing to guide the injector plunger during reciprocal movement. The lower guide is positioned axially between the lower supply chamber and the injection orifices. The injector plunger further includes a plurality of restriction orifices formed in the injector plunger and positioned symmetrically about the injector plunger to restrict fuel flow from the upper supply chamber to the lower supply chamber.

The plurality of restriction orifices may be limited to two orifices having central axes positioned in a common plane extending through a longitudinal axis of the injector plunger. The injector plunger may include an upper guide sized to form a close sliding fit with the nozzle housing to create a substantial fluid seal between the upper guide and the nozzle housing, and the plurality of restriction orifices may be formed in the upper guide. The nozzle housing may include a lower bore positioned between the lower supply chamber and the injector orifices to receive the injector plunger. The lower bore may have an outer diameter less than the outer diameter of the lower supply chamber. The lower guide may be positioned in the lower bore. The lower supply chamber may be defined at one end by the upper guide and at an opposite end by one end of the lower bore. The lower supply chamber may include an axial extent greater than an axial extent of the upper guide. Each of the plurality of restriction orifices may be positioned entirely on an opposite diametric side of the injector plunger from another one of the plurality of restriction orifices and in a common transverse plane extending perpendicular to a longitudinal axis of the injector plunger. The nozzle housing may be formed as one-piece and each of the plurality of restriction orifices, the upper guide, and the lower guide may be positioned in the one-piece nozzle housing. The lower guide may include fuel passages sized to permit unrestricted fuel flow through the fuel passages. The plurality of restriction orifices may each be linear passages having a longitudinal axis extending in a plane parallel to a longitudinal axis of the plunger. The injector plunger may further include a plurality of flow passages formed in the upper guide, and each of the plurality of flow passages may connect to, and have a larger cross-sectional flow area than, a respective one of the plurality of restriction orifices. A greater longitudinal portion of the lower bore is preferably positioned between the lower guide and the lower supply chamber than is positioned between the lower guide and the injector orifices.

This disclosure also provides a closed nozzle injector for injecting fuel at high pressure into the combustion chamber of an engine, comprising an injector body including an upper supply chamber and a nozzle housing, wherein the nozzle housing includes a lower supply chamber, a plunger seat, and injector orifices. An injector plunger is positioned in the nozzle housing for movement between a closed position in abutment against the plunger seat to block fuel flow through the injector orifices and an open position positioned a spaced distance from the plunger seat to permit fuel flow through the injector orifices. The injector plunger includes a lower guide sized to form a close sliding fit with the nozzle housing to guide the injector plunger during reciprocal movement and an upper guide sized to form a close sliding fit with the nozzle housing to create a substantial fluid seal between the upper guide and the nozzle housing. The injector plunger further includes a plurality of restriction orifices formed in the upper guide and positioned about the injector plunger. The plurality of restriction orifices are sized to restrict fuel flow from the upper supply chamber to the lower supply chamber.

### BRIEF DESCRIPTION OF DRAWINGS

FIG. 1 is a cross-sectional view of a portion of a prior art conventional injector showing the nozzle valve assembly and plunger;

FIG. 2 is an expanded cross-sectional view of a portion of the fuel injector of the present disclosure showing the nozzle assembly including the balanced and guided plunger;

FIG. 3 is a perspective view of a portion of the plunger showing the lower guide;

FIG. 4a is a side view of a portion of the plunger showing the upper guide;

FIG. 4b is a cross-sectional view of the plunger taken along plane 4b-4b in FIG. 4a;

FIGS. 5a and 5b are views within of cylinder of an engine facing upwardly showing the spray pattern of fuel from injector orifices of a conventional injector (FIG. 1) and the injector of FIG. 2, respectively; and

FIGS. 6a and 6b are injection rig measurement data comparing the shot-to-shot end of injection variation of a conventional injector and the injector of FIG. 2.

### DETAILED DESCRIPTION

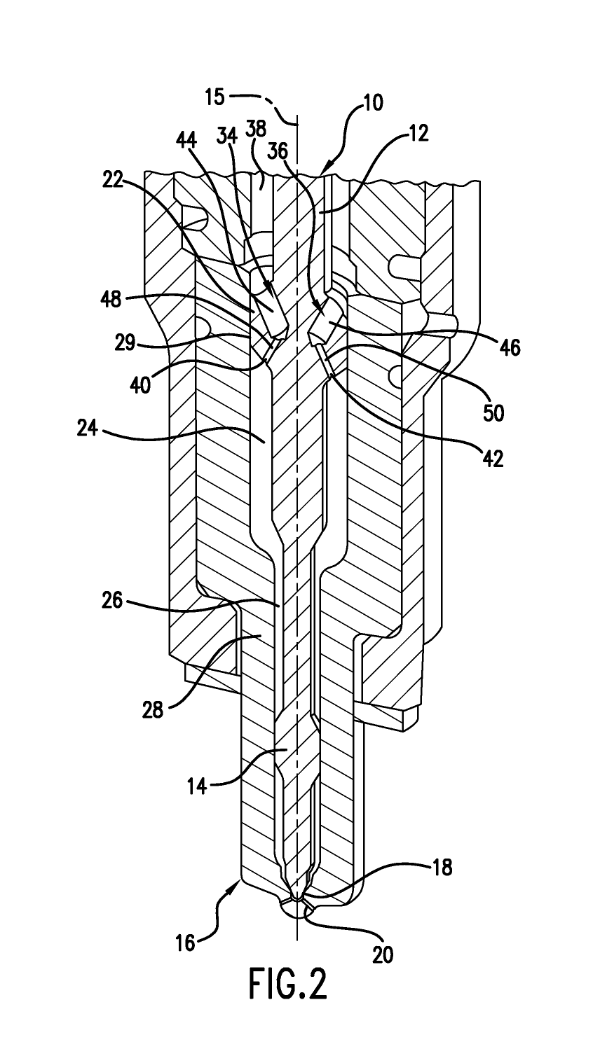

Referring to FIG. 2, an exemplary embodiment of the injector 10 of the present disclosure include an injector plunger 12 having a nozzle valve assembly 16 and injector plunger 12 that provides improved spray distribution, reduced nozzle cavitation, lower end of injection variation, and a faster injection rate shape. The plunger 12, also referred to as a needle or nozzle valve element, is mounted for reciprocal movement in nozzle assembly 16 between a closed position in abutment against a plunger seat 18 to block fuel flow through injector orifices 20 formed a nozzle housing 28 and an open position positioned a spaced distance from plunger seat 18 to permit fuel flow through injector orifices 20. As explained below, plunger 12 includes two balanced restriction or gain orifices 40, 42 for improved fueling control. In an exemplary embodiment, the orifices 40, 42 are formed in an upper guide 22 of plunger 12 positioned in, and at one end of, nozzle assembly 16.

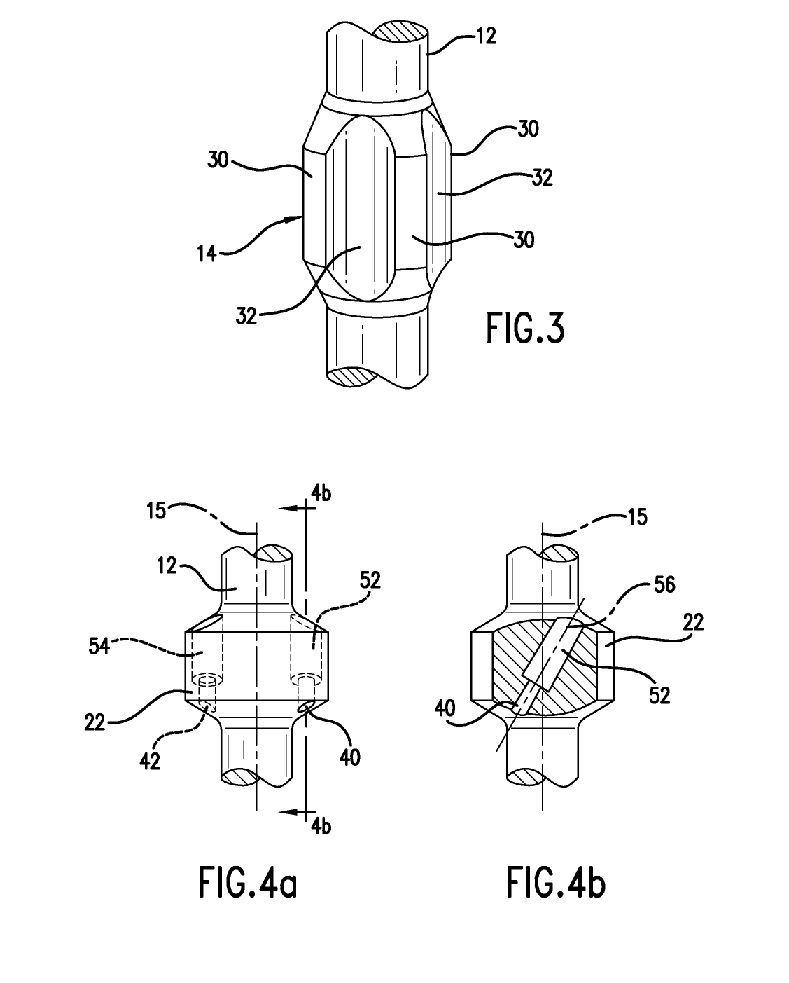

The annular radially protruding upper guide 22 is positioned at one end of an annular lower supply chamber 24 formed in the nozzle valve assembly 16 upstream of a lower guide 14 positioned in nozzle valve assembly 16 closely adjacent plunger seat 18. The lower supply chamber 24 is positioned longitudinally between the upper guide 22 and the lower guide 14 and includes an axial extent or length greater than an axial extent of the upper guide 22, and a radial width at least as wide as the radial width of the upper guide 22 resulting in a lower supply chamber 24 having a larger volume than other fuel passages located between upper guide 22 and lower guide 14. Both the upper guide 22 and the lower guide 14 are formed in, preferably, a one-piece nozzle housing 28 when the plunger 12 is assembled in the injector 10. The upper guide 22 is positioned adjacent an outer end of the nozzle housing 28 and includes an outer annular surface or extent 29 sized and positioned to form a close sliding fit with the inner wall or surface of the nozzle housing 28 to create a substantial fluid seal while permitting unhindered reciprocal movement. The lower guide 14 is positioned in a lower bore 26 having an outer diameter less than the outer diameter of the lower supply chamber 24. As shown in FIGS. 2 and 3, the lower guide 14 includes elongated guiding flutes 30 extending radially outwardly to form respective outer annular surfaces sized and positioned to form a close sliding fit with the inner wall of the nozzle housing 28 forming the lower bore 26, and axial passages 32 positioned between the flutes to connect the lower bore 26 above and below lower guide 14 permitting passage of fuel through lower guide 14. Preferably, axial passages 32 are sized to avoid any restriction in the fuel flow through guide 14 thereby permitting unrestricted fuel flow to injector orifices 20. The lower guide 14 is positioned axially along the lower bore 26 closer to the plunger or nozzle seat 18 than to the lower supply chamber 24. Therefore a greater longitudinal or axial portion of lower bore 26 is positioned above lower guide 14 than below lower guide 14. Also, the lower supply chamber 24 is positioned longitudinally/axially between upper guide 22 and upper end of lower bore 26 to receive fuel from restriction orifices 40, 42 and deliver fuel to the annular fuel passage positioned in lower bore 26 radially between the inner wall of nozzle housing 28 and the outer surface of injector plunger 12. In addition, the axial distance along the longitudinal axis 15 between upper guide 22 and lower guide 14 is at least twice the axial distance between lower guide 14 and valve seat 18

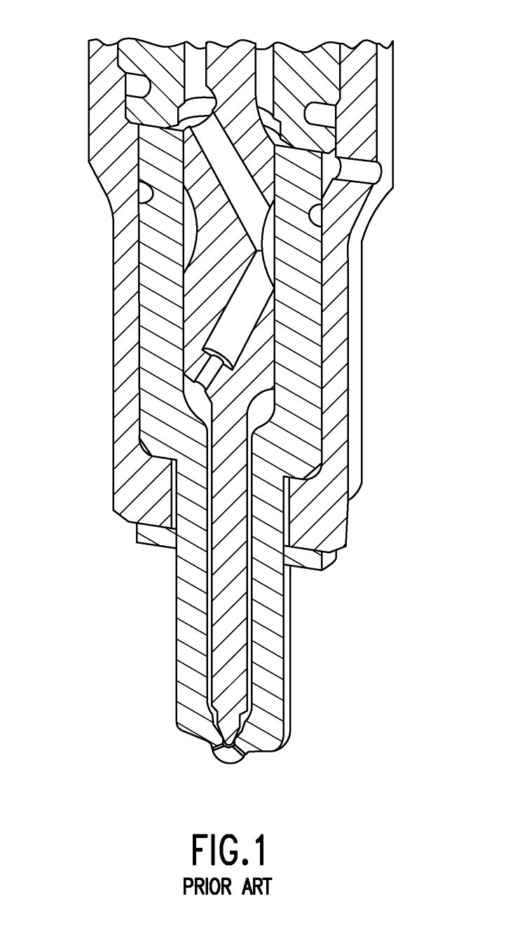

The plunger 12 further includes two flow passages 34, 36 formed in the upper guide 22 to connect an upper supply chamber 38 to the lower supply chamber 24. A respective gain orifice 40, 42, having a smaller cross-sectional flow area than the respective flow passage, is formed in each flow passage 34, 36 to restrict the flow of fuel from the upper supply chamber 38 to the lower supply chamber 24 to create a desired force profile on the plunger 12. The general operation of an inner restriction passage is discussed in U.S. Pat. No. 6,499,467, the entire contents of which is hereby incorporated by reference. The injector of U.S. Pat. No. 6,499,467 is also shown in FIG. 1, and represents the standard injector/plunger used as a comparison in the discussion, charts and graphs herein. Also, the upper portion of injector 10 not shown in FIG. 2 may be the same as the upper portion of the injector disclosed in U.S. Pat. No. 6,499,467.

As shown in FIG. 2, the passages 34, 36 and thus the orifices 40, 42 are symmetrically oriented in the injector plunger 12 to enhance plunger guiding, flow balance, and fuel control. In one exemplary embodiment, shown in FIG. 2, each passage 34, 36 may include a first angled passage 44, 46 extending downwardly from the upper supply chamber 38 and inwardly at an angle toward the longitudinal axis 15 of plunger 12 and a second angled passage 48, 50 connected with the first angled passage 44, 46, respectively, and extending outwardly and downwardly to connect with the lower supply chamber 24. In this first exemplary embodiment, the second angled passages 48, 50 form the orifices 40, 42, and the passages and orifices are all positioned in a common plane extending through the injector axis. Alternatively, the orifices may be formed along passages 48, 50. In another exemplary embodiment, shown in FIGS. 4a and 4b, each flow passage is formed by a single linear passage 52, 54 extending through the upper guide 22 and having a central axis 56 positioned in a plane parallel to the longitudinal axis 15 of plunger 12. Passages 52, 54 are positioned at an angle from the plunger axis 15 to connect the upper supply chamber 38 to the lower supply chamber 24. In the exemplary embodiments, lower supply chamber 24 is sized and positioned to provide an increased volume downstream of the gain orifices 40, 42 compared to conventional injectors.

An unexpected benefit of the plunger 12 and injector 10 is improved shot-to-shot EOI (end of injection) variation, resulting from the improved guiding and alignment. Another unexpected benefit of this design is a faster injection rate at the start of injection due to more volume downstream of the gain orifices 40, 42 (larger lower supply chamber 24), in addition to the improved guiding and alignment of the plunger 12. This benefit may also be due to less pressure reduction downstream of the gain orifices 40, 42 when the plunger lifts.

The balanced and guided plunger 12 has the following improvements:

1. Structural symmetry: The dual gain orifices 40, 42 are symmetrically positioned to advantageously eliminate bending in the injector plunger. Conventional designs using a single, or asymmetrical, inner restriction orifice, result in bending of the plunger around the notch when the injector is pressurized with fuel and the lower plunger is loaded, thereby undesirably creating eccentricity between the plunger tip and nozzle seat.
2. Hydraulic symmetry: The dual gain orifices 40, 42 balance the flow so there is not a hydraulic side force generated that pushes the plunger eccentrically when the plunger is lifted. The symmetrical positioning of the gain orifices allows fluid pressure and flow forces in one orifice/passage on one side of the plunger to be counteracted by fluid pressure and flow forces in the other orifice/passage on the other side of the plunger. As a result, the plunger reciprocates in a more linear manner along the desired longitudinal axis.
3. Improved guiding: At least the following features maintain the plunger tip centered on the nozzle seat 18 when the plunger lifts.

a. The upper 22 and lower 14 guides are spaced far apart in the nozzle housing 28.

b. The lower guide 14 is close to the nozzle seat 18.

c. The lower diameter guide is less subject to increased clearance when the nozzle housing 28 is pressurized and therefore provides improved guiding under pressure.

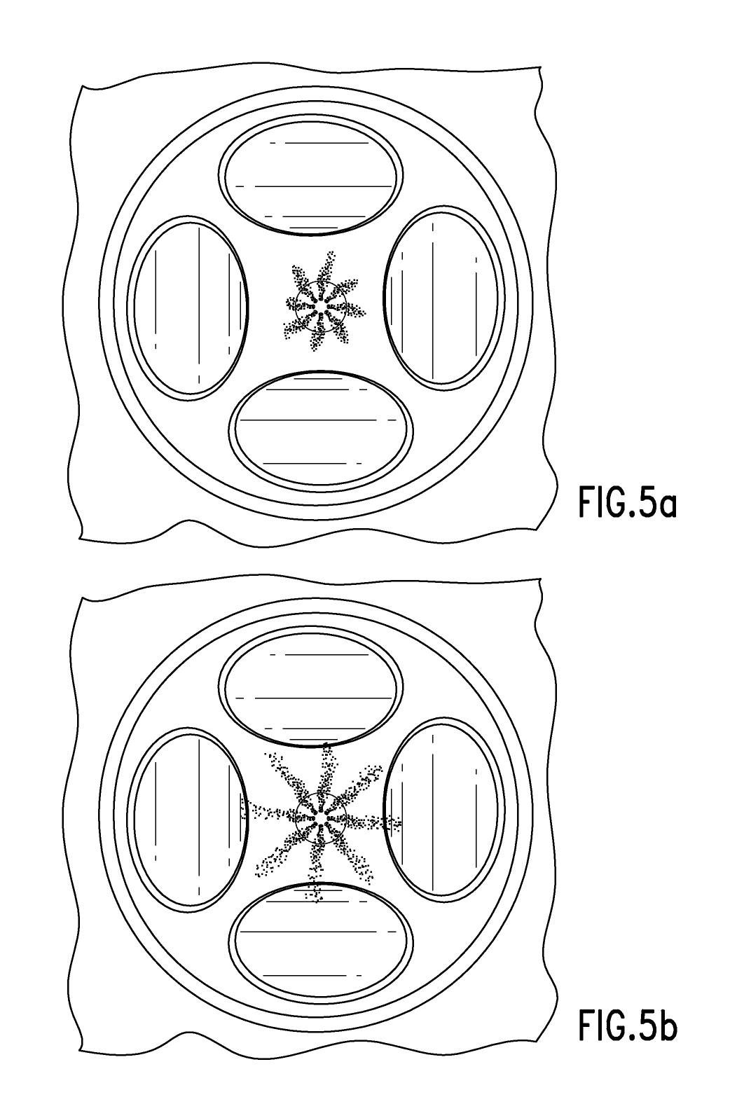

Calculations at 2600 bar indicate a 8 mm ID of the upper nozzle bore dilates 0.024 mm diametrically, whereas a 4 mm ID of the lower nozzle bore only dilates 0.010 mm diametrically. Optional machining of the gain orifices 40, 42 may also be used to provide through hole drilling for improved machining and less chance of burrs in drilling intersections. The improved guiding is evident by comparing the spray visualization photos of FIGS. 5a and 5b. FIG. 5a shows the injector spray distribution near the start of injection, which is when the plunger is just starting to lift, for a conventional injector, such as shown in FIG. 1, while FIG. 5b shows a more balanced and deeper/extended spray distribution near the start of injection for injector 10 including the present balanced and guided plunger 12.

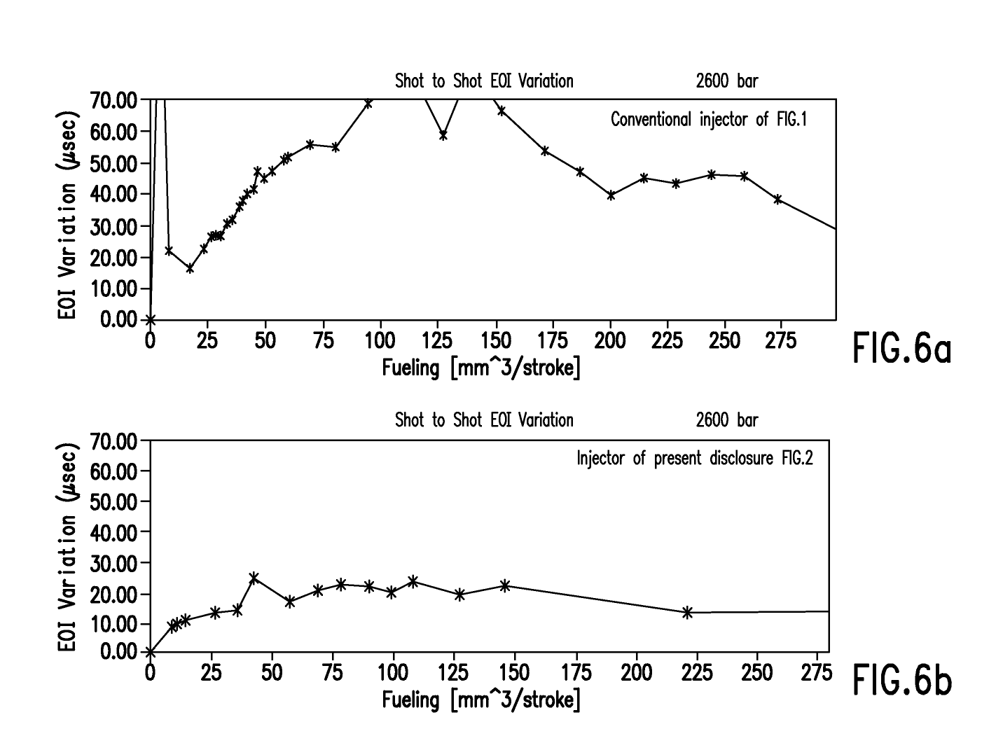

The balanced and guided plunger 12 also results in improved shot to shot EOI variation. FIGS. 6a and 6b are graphs showing test data comparing the EOI variation of a conventional injector with the injector 10 including the balanced and guided plunger 12 consistent with the present disclosure, respectively.

Another unexpected improvement has been a faster injection rate at the start of injection. The faster injection rate may be due to more volume downstream of the gain orifice as provided by the enlarged lower supply chamber, and also the improved guiding and alignment of the plunger. This benefit may also be due to less pressure reduction downstream of the gain orifices when the plunger lifts. CFD modeling with a centered plunger showed no spray hole cavitation. The CFD results have been confirmed with improvement in spray hole cavitation in several cavitation rig tests when comparing the conventional plungers with the present balanced and guided plunger 12.

While various embodiments in accordance with the present disclosure have been shown and described, it is understood that the disclosure is not limited thereto. The present disclosure may be changed, modified and further applied by those skilled in the art. Therefore, this disclosure is not limited to the detail shown and described previously, but also includes all such changes and modifications.

We claim:

1. A closed nozzle injector for injecting fuel at high pressure into the combustion chamber of an engine, comprising:
an injector body including an upper supply chamber and a nozzle housing, said nozzle housing including a lower supply chamber, a plunger seat, and injector orifices;
an injector plunger positioned in said nozzle housing for movement between a closed position in abutment against said plunger seat to block fuel flow through said injector orifices and an open position positioned a spaced distance from said plunger seat to permit fuel flow through said injector orifices, said injector plunger further including a plurality of restriction orifices formed in said injector plunger and positioned symmetrically about said injector plunger to restrict fuel flow from said upper supply chamber to said lower supply chamber.

2. The injector of claim 1, wherein said plurality of restriction orifices is limited to two orifices having central axes positioned in a common plane extending through a longitudinal axis of said injector plunger.

3. The injector of claim 1, wherein said injector plunger includes an upper guide sized to form a close sliding fit with said nozzle housing to create a substantial fluid seal between said upper guide and said nozzle housing, said plurality of restriction orifices formed in said upper guide.

4. The injector of claim 3, wherein said nozzle housing includes a lower bore positioned between said lower supply chamber and said injector orifices to receive said injector plunger, said lower bore having an outer diameter less than said outer diameter of said lower supply chamber.

5. The injector of claim 4, wherein said injector plunger includes a lower guide sized to form a close sliding fit with said nozzle housing to guide said injector plunger during reciprocal movement, said lower guide positioned axially between said lower supply chamber and said injection orifices.

6. The injector of claim 4, wherein said lower supply chamber is defined at one end by said upper guide and at an opposite end by one end of said lower bore, said lower supply chamber includes an axial extent greater than an axial extent of said upper guide.

7. The injector of claim 3, wherein each of said plurality of restriction orifices is positioned entirely on an opposite diametric side of said injector plunger from another one of said plurality of restriction orifices and in a common transverse plane extending perpendicular to a longitudinal axis of said injector plunger.

8. The injector of claim 3, wherein said nozzle housing is formed as one-piece, each of said plurality of restriction orifices and said upper guide being positioned in said one-piece nozzle housing.

9. The injector of claim 1, wherein said lower guide includes fuel passages sized to permit unrestricted fuel flow through said fuel passages.

10. The injector of claim 1, wherein said plurality of restriction orifices are each linear passages having a longitudinal axis extending in a plane parallel to a longitudinal axis of said plunger.

11. The injector of claim 3, wherein said injector plunger further includes a plurality of flow passages formed in said upper guide, each of said plurality of flow passages connecting to, and having a larger cross-sectional flow area than, a respective one of said plurality of restriction orifices.

12. The injector of claim 5, wherein a greater longitudinal portion of said lower bore is positioned between said lower guide and said lower supply chamber than is positioned between said lower guide and said injector orifices.

13. A closed nozzle injector for injecting fuel at high pressure into the combustion chamber of an engine, comprising:
an injector body including an upper supply chamber and a nozzle housing, said nozzle housing including a lower supply chamber, a plunger seat, and injector orifices;
an injector plunger positioned in said nozzle housing for movement between a closed position in abutment against said plunger seat to block fuel flow through said injector orifices and an open position positioned a spaced distance from said plunger seat to permit fuel flow through said injector orifices, said injector plunger including a lower guide sized to form a close sliding fit with said nozzle housing to guide said injector plunger during reciprocal movement and an upper guide sized to form a close sliding fit with said nozzle housing to create a substantial fluid seal between said upper guide and said nozzle housing, said injector plunger further including a plurality of restriction orifices formed in said upper guide and positioned about said injector plunger, said plurality of restriction orifices sized to restrict fuel flow from said upper supply chamber to said lower supply chamber.

14. The injector of claim 13, wherein said plurality of restriction orifices are positioned symmetrically about said injector plunger.

15. The injector of claim 13, wherein said plurality of restriction orifices are limited to two orifices having central axes positioned in a common plane extending through a longitudinal axis of said injector plunger.

16. The injector of claim 13, wherein said nozzle housing includes a lower bore positioned between said lower supply chamber and said injector orifices to receive said injector plunger, said lower bore having an outer diameter less than said outer diameter of said lower supply chamber.

17. The injector of claim 16, wherein said lower supply chamber is defined at one end by said upper guide and at an opposite end by one end of said lower bore, said lower supply chamber includes an axial extent greater than an axial extent of said upper guide.

18. The injector of claim 13, wherein said nozzle housing is formed as one-piece, each of said plurality of restriction orifices, said upper guide, and said lower guide being positioned in said one-piece nozzle housing.

19. The injector of claim 13, wherein said plurality of restriction orifices are each linear passages having one end connected to said upper supply chamber and an opposite end connected to said lower supply chamber.

20. The injector of claim 16, wherein a greater longitudinal portion of said lower bore is positioned between said lower guide and said lower supply chamber than is positioned between said lower guide and said injector orifices.
